(19) United States
(12) Patent Application Publication
(10) Pub. No.: US 2008/0297555 A1
(43) Pub. Date: Dec. 4, 2008

(54) ARRAY TYPE INKJET HEAD AND METHOD OF MANUFACTURING THE SAME

(75) Inventors: Seo-hyun Cho, Seongnam-si (KR); Jung-wook Kim, Yongin-si (KR); Yang-hoe Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/939,029

(22) Filed: Nov. 13, 2007

(30) Foreign Application Priority Data
May 30, 2007 (KR) 2007-52923

(51) Int. Cl. B41J 29/393; B23P 17/00; B41J 2/145

(52) U.S. Cl. 347/19; 29/890.1; 347/41

(57) ABSTRACT

An array type inkjet head and a method of manufacturing the same are provided. The method includes providing a test head in which nozzle chips are mounted, printing ejection patterns on a printing medium according to various ejection timings of the nozzle chips by controlling the test head, classifying the nozzle chips into groups according to the ejection patterns, and assembling the nozzle chips that are classified in the same group having the same ejection pattern on the array type inkjet head. Since the array type inkjet head is manufactured by grouping together the nozzle chips having the same ejection pattern, poor printing results can be prevented.

### CROSS-REFERENCE TO RELATED APPLICATIONS

This application claims the benefit of Korean Patent Application No. 10-2007-0052923, filed on May 30, 2007 in the Korean Intellectual Property Office, the disclosure of which is incorporated herein in its entirety by reference.

### BACKGROUND OF THE INVENTION

1. Field of the Invention

The present general inventive concept relates to an array type inkjet head having a plurality of nozzle chips arranged along the width direction of a printing medium to print line by line, and more particularly, to an array type inkjet head that minimizes differences between the ejection directions of ink droplets ejected from the nozzle chips.

2. Description of the Related Art

In general, an inkjet printer is a printing device that prints predetermined images by ejecting ink droplets onto desired locations on a printing medium and can be classified as either a shuttle type inkjet printer or an array type inkjet printer. The shuttle type inkjet printer includes a print head including a single nozzle chip that prints by reciprocally moving in the width direction of a printing medium. The array type inkjet printer includes a plurality of nozzle chips arranged along the width direction of a printing medium, and prints line by line. Recently, printers having an array type head are preferred due to increased printing speed.

However, the array type inkjet head, which is advantageous in terms of printing speed, uses, as described above, multiple nozzle chips mounted therein, and thus the image density may not be uniform when there is a slight difference in the ejection directions of the nozzle chips. In other words, since the array type inkjet head usually uses fourteen (14) nozzle chips arranged along the width direction of a printing medium, it is ideal if all the nozzle chips eject droplets in the same direction. However, when some of the nozzle chips have different ejection directions than others, the image density and quality corresponding to the nozzle chips that have different ejection directions becomes different from the rest. The problem is that minute differences in the ejection directions of the nozzle chips frequently occur in array type inkjet heads, as described below with reference to the drawings.

First, the structure of one of a plurality of conventional nozzle chips 10 will be described schematically. As illustrated in FIG. 1, nozzle holes 11 are formed along a first line L1 and a second line L2 in a zigzag, or offset, formation, where one of the two lines is usually denoted as an even line, and the other line is denoted as an odd line. The nozzle holes 11 are formed along the first and second lines L1 and L2 in the zigzag formation in order to realize high printing resolution and to reduce manufacturing difficulties which may occur if the distance between the nozzle holes 11 is too small.

For example, to realize a resolution of 1200 dpi, if the nozzle holes 11 are only formed along a single line, the distance between the nozzle holes 11 needs to be adjusted to be 1/1200 of an inch, which makes the manufacturing process difficult. However, when the nozzle holes are formed along the first and second lines L1 and L2, as illustrated in FIG. 1, the distance between the nozzle holes 11 in each line can be adjusted to be 1/600 of an inch, and thus the manufacturing difficulties can be remarkably reduced. As obvious to one skilled in the art, in this embodiment, a controller controls the ink ejection timing of the first line L1 and the second line L2 such that ink droplets ejected from the first line L1 of nozzle holes 11 and droplets ejected from the second line L2 of nozzle holes 11 will fall on the same line on the printing medium. Conventionally, the distance d between the first line L1 and the second line L2 is 10 dots, that is, 10/1200 of an inch, and the distance between the nozzle holes 11 and the printing medium is about 1 mm. Thus, by controlling the ejection timing by calculating the moving speed of the printing medium, and by selecting a proper distance d between lines L1 and L2, ink droplets ejected from the nozzles 11 of the first line L1 and the second line L2 can fall on the same line on the printing medium.

Such controlling is performed by assuming that the droplets ejected from the nozzle holes 11 of the first and second lines L1 and L2 are ejected vertically downward to the printing medium P, as illustrated in FIG. 2A. However, in practice, the ejection directions may be slightly off-vertical caused by a slight deformation of the nozzle chip 10 as illustrated in FIG. 2B. That is, ideally, all of the nozzle chips 10 should be controlled to eject ink droplets vertically downward as illustrated in FIG. 2A, however, due to the characteristics of the manufacturing process of the nozzle chips 10, the ejection directions of the nozzles 11 of the first and second lines L1 and L2 may be slightly distorted due to various factors such as the slight deformation of the nozzle chip 10 as illustrated in FIG. 2B.

Since the controller controls the ejection timing on the assumption that ink droplets are ejected vertically downward as illustrated in FIG. 2A and since, as illustrated in FIG. 2B, the ink droplets actually ejected from the nozzles 11 of the first line L1 and the second line L2 in practice do not fall vertically downward as intended, but instead fall outside of the expected locations of the printing medium P, this results in a non-uniform image density, on the medium P. If the distortion of the ejection directions of nozzle holes 11 occurs to the same degree in all of the nozzle chips 10, the controller may be capable of adjusting the ejection timing in consideration of the degree of distortion. However, since the deformation of each nozzle chip 10 may be different, the ejection timing in such a case cannot be adjusted uniformly by the controller.

Accordingly, there is a need to minimize the difference in the ejection directions of the nozzle chips 10 mounted on an array type inkjet head.

### SUMMARY OF THE INVENTION

The present general inventive concept provides an array type inkjet head that is improved to obtain uniform image density by reducing differences in the ejection directions of a plurality of nozzle chips, and a method of manufacturing the same.

Additional aspects and utilities of the present general inventive concept will be set forth in part in the description which follows and, in part, will be obvious from the description, or may be learned by practice of the general inventive concept.

The forgoing and/or other aspects and utilities of the present general inventive concept may be achieved by providing an array type inkjet head including a plurality of nozzle chips mounted on the array type inkjet head which ejects ink, wherein the nozzle chips all have substantially a same ejection pattern of ink droplets.

Each of the nozzle chips may include a plurality of nozzle holes disposed along a first line and a second line to print on a printing medium, and the ejection pattern may be represented by an image that is formed on a printing medium according to a variation of ejection timing between the first line and the second line.

The first line and second line may be parallel to each other.

The ejection pattern may be non-vertical.

The variation of ejection timing may be based on a non-actual distance between the first line and the second line.

The plurality of nozzle holes are arranged in a zigzag pattern.

The forgoing and/or other aspects and utilities of the present general inventive concept may be achieved by providing a method of manufacturing an array type inkjet head, the method including providing a test head on which a nozzle chip is mounted, printing on a printing medium an ejection pattern according to a variation of ejection timing of the nozzle chip by controlling the test head, classifying the nozzle chip according to the ejection pattern, and assembling nozzle chips that are classified as having the same ejection pattern on the array type head.

The nozzle chip may have a plurality of nozzle holes formed along a first line and a second line to print one line on a printing medium, wherein the ejection pattern is formed on the printing medium according to the variation of ejection timing between the first line and the second line.

The ejection timing between the first line and the second line may be selected assuming that the distance between the first line and the second line is increased or decreased in steps of 0.2 to 0.5 dots.

Ink droplets may be ejected from the plurality of nozzle holes formed along the first line and the second line and may be printed on the printing medium at distances of 1/600 of an inch between droplets.

The forgoing and/or other aspects and utilities of the present general inventive concept may be achieved by providing a method of testing an inkjet nozzle chip, the method including providing an inkjet nozzle chip mounted on a test head, selecting a value to represent a distance between two rows of nozzle holes formed in the inkjet nozzle chip, and controlling ejection timing of ink droplets ejected by the inkjet nozzle chip by the use of the selected value, wherein the droplets ejected by the inkjet nozzle chip form an ejection pattern that corresponds to the selected value.

A plurality of ejection patterns may be formed for the inkjet chip, each being formed in a separate iteration, by controlling the ejection timing of the ink droplets during each iteration by selecting for each iteration a unique value such that each unique value selected for each iteration may corresponds to a different one of the plurality of ejection patterns.

An ejection pattern may be determined from the plurality of ejection patterns that may represent the most accurate printed image and the corresponding selected value for that determined ejection pattern.

The forgoing and/or other aspects and utilities of the present general inventive concept may be achieved by providing an array type inkjet head including a plurality of nozzle chips having nozzle openings spaced apart in a direction from each other by a distance, wherein the nozzle openings eject ink droplets on a printing medium to have the same effective distance between the ink droplets of the respective nozzle openings in the direction.

The array type inkjet head where there may be a difference between the distance and the effective distance equal to or less than 0.5 dot.

The array type inkjet head where the effective distance may have a deviation equal to or less than 0.5 dot.

The array type inkjet head where the nozzle openings may eject the ink droplets at an angle with respect to the surface of the head such that the ink droplets are formed at the same effective distance.

The forgoing and/or other aspects and utilities of the present general inventive concept may be achieved by providing a method of testing an inkjet nozzle chip including selecting a plurality of nozzle chips as a first group of nozzle chips having a first effective distance and as a second group of nozzle chips having a second effective distance, and mounting the first group of nozzle chips on a first head and mounting the second group of nozzle chips on a second head.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates the structure of a conventional nozzle chip that is mounted on an array type inkjet head;

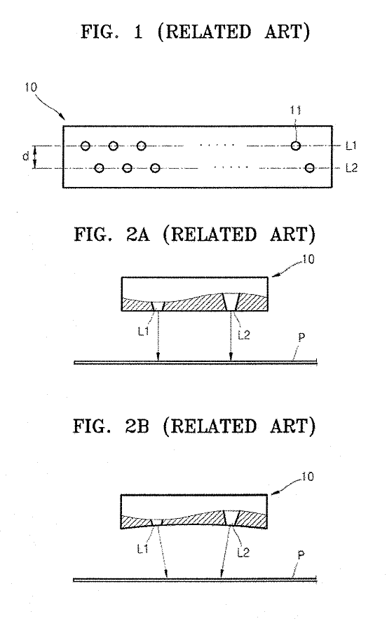

FIG. 2A illustrates vertical ejection directions of ink droplets of the conventional nozzle chip illustrated in FIG. 1;

FIG. 2B illustrates distortion by differences in the ejection directions of ink droplets of the conventional nozzle chip illustrated in FIG. 1;

FIG. 3 illustrates a test head that is prepared to test and manufacture an array type inkjet head, according to an embodiment of the present general inventive concept;

FIGS. 4 and 5A through 5D illustrate examples of ejection patterns printed using the test head illustrated in FIG. 3; and

FIG. 6 illustrates the array type inkjet head manufactured using a method of manufacturing and testing according to the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

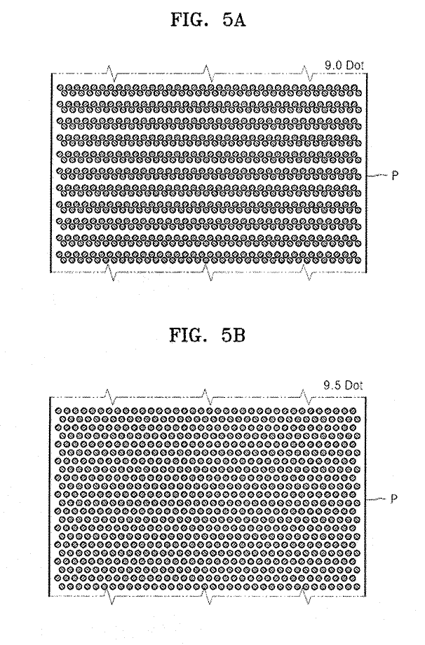

FIGS. 3 through 6 illustrate a manufacturing process to test and manufacture an array type inkjet head 200 according to an embodiment of the present general inventive concept.

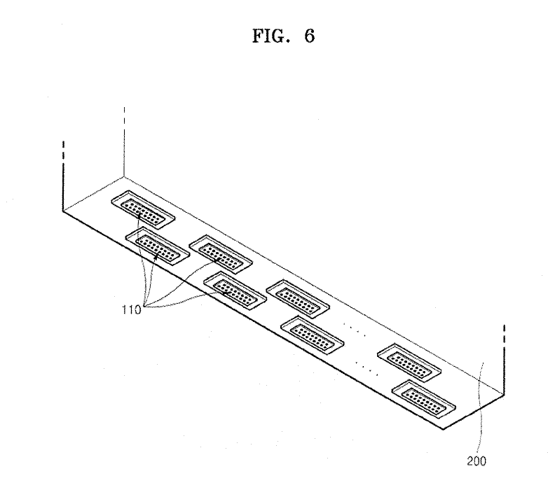

First, as illustrated in FIG. 3, a test head 100, on which a nozzle chip 110 is mounted, is provided. The test head 100 is provided to test an ejection pattern of a plurality of nozzle chips 110, but as illustrated, includes only one nozzle chip 110, unlike an actual array type inkjet head 200 which includes a plurality of nozzle chips 110 (refer to FIG. 6). Since the nozzle chip 110 needs to be removable from the test head 100, the nozzle chip 110 is held in place via removable screws 121 so that the nozzle chip 110 can be easily detached from the test head 100. A chip module 120 supports the nozzle chip 110 and connects the body of the test head 100 with a channel of ink. During testing, the chip module 120 is attached to the nozzle chip 110 as a single body and is separated from the test head 100 afterwards. When the chip module 120 is actually mounted on an array type inkjet head 200, as described above, the chip module 120 is mounted as a single body together with the nozzle chip 110. As described above, nozzle holes 111 are formed in the nozzle chip 110 along a first line L1 and a second line L2 in a zigzag, or offset, formation, and the first line L1 and the second line L2 are spaced apart from each other by a distance d, for example, 10 dots and the distance d is set during the manufacturing process of the nozzle chip 110. The distance d corresponding to 10 dots may be 10/1200 of an inch when a resolution of nozzle chip 100 is 1200 dpi.

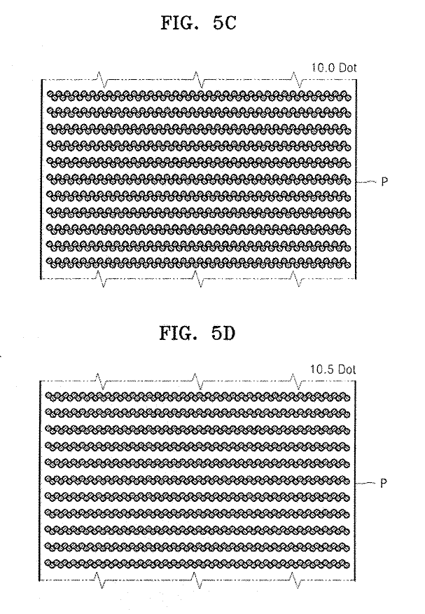

As illustrated in FIG. 4, when the test head 100 is provided, printing is performed several times for testing while printing mediums P are passed below the head 100. In each printing, an image is printed such that ink droplets ejected from the first line L1 of nozzle holes 111 and ink droplets ejected from the second line L2 of nozzle holes 111 are spaced apart by 1/600 of an inch on the printing medium P. During the actual printing process, the ink droplets ejected from the first and second lines L1 and L2 are printed on one line of a printing medium P to realize high printing resolution such as 1200 dpi, however, in order to see the ejection pattern more easily, an image is printed such that ink droplets ejected from the first and second lines L1 and L2 are spaced apart by 1/600 of an inch, respectively. To this end, a controller 100a sets the ejection timing for the first and second lines L1 and L2 in consideration of the distance d between the first and second lines L1 and L2 such that an image is printed on a printing medium P having a distance of 1/600 of an inch between ink droplets.

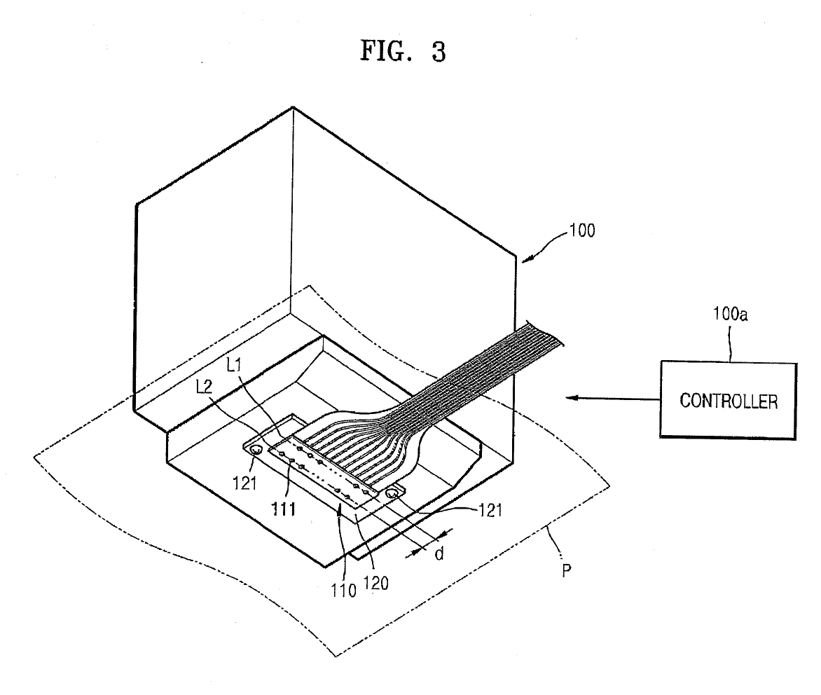

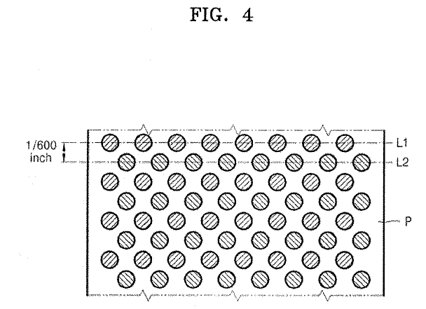

For example, if the lines of nozzle chips 110 are manufactured to be separated by a distance of 10 dots as described above, the ejection timing is selected assuming that the distance d between the first and second line L1 and L2 is 10 dots and then an image is printed for testing. The printed image illustrates the ejection pattern. Then, an image is printed again assuming that the distance d between the first and second lines L1 and L2 is shorter or longer than 10 dots, that is, by selecting an effective distance d_{eff}, where the distance between the first and second lines L1 and L2 is not equal to the actual distance. This step is repeated over a range of values for d_{eff}. The reason that this is done, as described with reference to FIG. 2A, is that if ink droplets from the first and second lines L1 and L2 are ejected vertically downward, the droplets will be printed at distances between them of 1/600 of an inch, as is expected when the ejection timing is selected on the assumption that the distance d between the first and second lines L1 and L2 is the actual distance d_{act} of 10 dots. However, if the ejection direction of the droplets of the first and second lines L1 and L2 is distorted, as illustrated in FIG. 2B, a non-distorted image cannot be printed by using the actual distance d_{act} (10 dots) between the first and second lines L1 and L2.

Accordingly, when printing results for images are obtained as illustrated in FIGS. 5A through 5D, for an effective distance d_{eff} varying from 9.0 dots to 10.5 dots in incremental units of 0.5 dots, it can be seen, as illustrated in FIG. 5B that the most accurate image is printed when the effective distance d_{eff} between the first and second lines L1 and L2 of the nozzle chip 110 is selected to be 9.5 dots. Accordingly, although the actual distance d_{act} between the first and second lines L1 and L2 of the tested nozzle chip 110 is 10 dots, an image is printed on the exact expected position on a printing medium P on the assumption that the effective distance d_{eff} between the first and second lines L1 and L2 is 9.5 dots. Accordingly, when tests are repeated on different nozzle chips 110 in this manner, the nozzle chips 110 can be classified into groups of nozzle chips 110 having the same or substantially same ejection pattern. In other words, it can be seen in this example that printing is most accurate when the effective distance d_{eff} between lines L1 and L2 of some of nozzle chips 110 is selected to be 9.5 dots. Hence, for testing, the effective distance d_{eff} is changed in steps of 0.5 dots. If the selected effective distance d_{eff} is too small, the test frequency becomes too large, and if the selected effective distance d_{eff} is too large, the classification of nozzle chips 110 may become inaccurate. Thus in this embodiment, the effective distance d_{eff} may be selected such that it will increment in steps of from 0.2 to 0.5 dots.

Thereafter, the nozzle chips 110 that are classified are grouped together such that all the nozzle chips 110 in a group have the same or substantially the same effective distance d_{eff}. Only nozzle chips 110 of the same group are mounted and assembled in an array head 200. In other words, the nozzle chips 110 with which printing is accurate at an effective distance d_{eff} of 9.5 dots are grouped together and then assembled together in one array head, and the nozzle chips 110 with which printing is accurate at an effective distance d_{eff} of 10.5 dots are grouped together and then assembled together in a different array head.

Thus, as the nozzle chips 110 having the same ejection pattern, (i.e. having the same or substantially the same effective distance d_{eff}) are assembled on the same array head 200, accurate images can be printed by the nozzle chips 110 according to the ejection timing set by the controller 100a for each ejection pattern. That is, in the conventional art, since the ejection patterns of the nozzle chips 110 in one array head are different with each other, the distance d between the first and second lines L1 and L2 cannot be adjusted to correspond to a predetermined pattern. However, according to the present general inventive concept, since only the nozzle chips 110 that are grouped together having the same or substantially same ejection pattern are installed on the same array head 200, the effective distance d_{eff} between the first and second lines L1 and L2 can be adjusted and selected for the unique ejection pattern of the group, and thus high quality, non-distorted images can be printed.

A nozzle chip 110 printing a single color is described above for convenience of description. Nozzle chips 110 printing multiple colors can also be classified and grouped together that have the same or substantially same ejection pattern according to the above described tests and grouping methods. That is, in the case of color nozzle chips 110, four sets of nozzle holes 111, each ejecting a color in a first line and a second line, are included. Likewise, test printing may be performed by varying the effective distance d_{eff} between the first and second lines of the nozzle chips 110 for each color individually and then the nozzle chips 110 can be classified and grouped together by those having the same or substantially same ejection pattern. Then, the nozzle chips 110 having the same or substantially same ejection pattern which have been grouped together are mounted on the same array head.

As described above and illustrated in FIG. 6, the array type inkjet head 200 according to the present general inventive concept is manufactured by grouping nozzle chips 110 having the same or substantially same ejection patterns, and thus poor printing quality, where there are image density differences between the nozzle chips 110, can be prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An array type inkjet head comprising:
a plurality of nozzle chips mounted on the array type inkjet head which ejects ink,
wherein the nozzle chips all have substantially a same ejection pattern of ink droplets.

2. The array type inkjet head of claim 1, wherein each of the nozzle chips includes a plurality of nozzle holes disposed along a first line and a second line to print on a printing medium, and the ejection pattern is represented by an image that is formed on a printing medium according to a variation of ejection timing between the first line and the second line.

3. The array type inkjet head of claim 2, wherein the first line and second line are parallel to each other.

4. The array type inkjet head of claim 1, wherein the ejection pattern is non-vertical.

5. The array type inkjet head of claim 2, wherein the variation of ejection timing is based on a non-actual distance between the first line and the second line.

6. The array type inkjet head of claim 3, wherein the plurality of nozzle holes are arranged in a zigzag pattern.

7. A method of manufacturing an array type inkjet head, the method comprising:
providing a test head on which a nozzle chip is mounted;
printing on a printing medium an ejection pattern according to a variation of ejection timing of the nozzle chip by controlling the test head;
classifying the nozzle chip according to the ejection pattern; and
assembling nozzle chips that are classified as having the same ejection pattern on the array type head.

8. The method of claim 7, wherein the nozzle chip has a plurality of nozzle holes formed along a first line and in a second line to print one line on a printing medium,
wherein the ejection pattern is formed on the printing medium according to the variation of ejection timing between the first line and the second line.

9. The method of claim 8, wherein the ejection timing between the first line and the second line is selected assuming that the distance between the first line and the second line is increased or decreased in steps of 0.2 to 0.5 dots.

10. The method of claim 8, wherein ink droplets are ejected from the plurality of nozzle holes formed along the first line and the second line and are printed on the printing medium at distances of 1/600 of an inch between droplets.

11. A method of testing an inkjet nozzle chip, comprising:
providing an inkjet nozzle chip mounted on a test head;
selecting a value to represent a distance between two rows of nozzle holes formed in the inkjet nozzle chip; and
controlling ejection timing of ink droplets ejected by the inkjet nozzle chip by the use of the selected value, wherein the droplets ejected by the inkjet nozzle chip form an ejection pattern that corresponds to the selected value.

12. The method of claim 11, wherein a plurality of ejection patterns are formed for the inkjet chip, each being formed in a separate iteration, by controlling the ejection timing of the ink droplets during each iteration by selecting for each iteration a unique value such that each unique value selected for each iteration corresponds to a different one of the plurality of ejection patterns.

13. The method of claim 12, including determining from the plurality of ejection patterns an ejection pattern that represents the most accurate printed image and the corresponding selected value for that determined ejection pattern.

14. An array type inkjet head, comprising:
a plurality of nozzle chips having nozzle openings spaced apart in a direction from each other by a distance, wherein the nozzle openings eject ink droplets on a printing medium to have the same effective distance between the ink droplets of the respective nozzle openings in the direction.

15. The array type inkjet head of claim 14, wherein a difference between the distance and the effective distance is equal to or less than 0.5 dot.

16. The array type inkjet head of claim 14, wherein the effective distance has a deviation equal to or less than 0.5 dot.

17. The array type inkjet head of claim 14, wherein the nozzle openings eject the ink droplets at an angle with respect to the surface of the head such that the ink droplets are formed at the same effective distance.

18. A method of testing an inkjet nozzle chip, comprising:
selecting a plurality of nozzle chips as a first group of nozzle chips having a first effective distance and as a second group of nozzle chips having a second effective distance; and
mounting the first group of nozzle chips on a first head and mounting the second group of nozzle chips on a second head.
